(19) United States
(12) Patent Application Publication
(10) Pub. No.: US 2006/0041716 A1
(43) Pub. Date: Feb. 23, 2006

(54) Optical read/write apparatuses and methods for write frequency management

(75) Inventors: Shun-Chin Lin, Chungli (TW); Wei-Tse HSU, Taipei City (TW); Hung-Ping Liu, Chungho (TW); Tsang-Jung Hu, Hsinchuang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/207,975

(22) Filed: Aug. 19, 2005

(30) Foreign Application Priority Data
Aug. 20, 2004 (TW) 93125120

(51) Int. Cl. G06F 13/28

(52) U.S. Cl. 711/112; 711/165

(57) ABSTRACT

A method of write frequency management for writing recorded data to an optical rewritable storage medium. The optical rewritable storage medium comprises a data area and a count area. The data area comprises multiple data units, the count area comprises multiple values, and each value represents a write frequency corresponding to one of the data units. The method receives a data write instruction comprising a write address range and the recorded data, writes the recorded data to the data units corresponding to the write address range, and updates the values corresponding to the write address range.

### BACKGROUND

The present invention relates to optical read/write apparatuses, and more particularly, to optical read/write apparatus for write frequency management.

Conventional optical storage devices include optical read drives and optical read/write drives. Optical storage media includes compact disks (CDs), CD-RW, digital versatile disks (DVDs), DVD-RWs, DVD+RWs and super audio compact disks (SACDs). Optical read drives include Compact Disc-Read Only Memory (CD-ROM) drives, which can read CD-based data, Digital Video Disc-Read Only Memory (DVD-ROM) drives, which can read DVD and CD-based data, and super audio compact disk-Read Only Memory (SACD-ROM), which can read SACD-based data. Optical read/write drives include Compact Disc-Read/Write (CD-RW) drives, which can read and write CD-based data, DVD-RW and DVD+RW drives, which can read and write DVD-based data, and SACD-RW, which can read and write SACD-based data.

FIG. 1 is a schematic diagram of a conventional optical rewritable storage medium. A conventional optical rewritable storage medium measures 12 cm in diameter, and includes a lead-in area 11, a program/data area 12 and a lead-out area 13. The audio or computer data is stored from radius 25 mm (after the lead-in) to radius 58 mm maximum where the lead-out starts. For example, the CD lead-in area precedes track one. This area records table of contents (TOC) data preceding the program/data area 12. The main channel in the CD lead-in area contains audio or data null information. This area is coded as track zero but is not directly addressable via the command set. The Q sub-channel in this area is coded with the TOC information. The CD lead-out area is beyond the last information track. The main channel in the CD lead-out area contains audio or data null information. Alternatively, the DVD lead-in area comprises physical sectors 1.2 mm wide or greater adjacent to the inside of the data area. This area records the control data and precedes the data area. The DVD lead-out area comprises 1.0 mm wide, or greater physical sectors adjacent to the outside of the data area in a single layered disc for a parallel track path (PTP) disc, or area comprising physical sectors 1.2 mm wide or more adjacent to the inside of the data area in layer 1 of opposite track path (OTP) disc.

The upper surface of optical rewritable storage media will typically fail to record audio or computer data after 100 writings. In view of these limitations, a need exists for optical read/write apparatuses and methods of write frequency management.

### SUMMARY

Optical rewritable storage media are provided. An exemplary embodiment of an optical rewritable storage medium comprises a data area and a count area. The data area comprises multiple data units, the count area comprises multiple values, and each value represents a write frequency corresponding to one of the data units. In some embodiments, the count area comprises at least one segment, each segment comprises at least one block, and each block comprises a portion of the values. The count area comprises multiple pages, the page comprises all segments, and each segment comprises a segment write frequency. The optical rewritable storage medium may be a CD-RW, DVD-RW or DVD+RW. The data unit may be a data block, a packet or an error correction code (ECC) block.

Methods for write frequency management are provided. An exemplary method of write frequency management receives a data write instruction comprising a write address range and the recorded data, writes the recorded data to the data units corresponding to the write address range, and updates the values corresponding to the write address range.

Some embodiments of a method for write frequency management may further load the values in the segment corresponding to the write address range from the count area to a buffer, update each-value corresponding to the write address range in the buffer, and write the values in the buffer to the corresponding segment. The method may further acquire the segment write frequency in the segment in the buffer, update the acquired segment write frequency, and write the updated segment write frequency to the corresponding segment in the count area. The method may further acquire all segment write frequencies in the page, acquire a maximum segment write frequency among the acquired segment write frequencies, determine whether the maximum segment write frequency exceeds a threshold, and duplicate data in the page to the next page if the maximum segment write frequency exceeds the threshold. The threshold may be between 90 and 110.

A machine-readable storage medium storing a computer program which, when executed, performs the method of write frequency management is also disclosed.

Optical read/write apparatuses for write frequency management are provided. An exemplary embodiment of an optical read/write apparatus comprises a read/write component and a processing unit. The processing unit receives a data write instruction comprising a write address range and the recorded data, directs the read/write component to write the recorded data to the data units corresponding to the write address range, and directs the read/write component to update the values corresponding to the write address range. The processing unit may further direct the read/write component to load the values in the segment corresponding to the write address range from the count area to a buffer, to update each value corresponding to the write address range in the buffer, and to write the values in the buffer to the corresponding segment. The processing unit may further direct the read/write component to acquire the segment write frequency in the segment in the buffer, to update the acquired segment write frequency, and to write the updated segment write frequency to the corresponding segment in the count area. The processing unit may further direct the read/write component to acquire all segment write frequencies in the page, to acquire a maximum segment write frequency among the acquired segment write frequencies, to determine whether the maximum segment write frequency exceeds a threshold, and to duplicate data in the page to the next page if the maximum segment write frequency exceeds the threshold. The threshold may be between 90 and 110.

### DESCRIPTION OF THE DRAWINGS

Optical read/write apparatuses and methods for write frequency management will become apparent by referring to the following detailed description of embodiments with reference to the accompanying drawings, wherein:

FIG. 1 is a schematic diagram of a conventional optical rewritable storage medium;

FIG. 2 shows a diagram of an embodiment of an optical read/write apparatus;

FIG. 3 is a schematic diagram of an embodiment of an optical rewritable storage medium;

FIGS. 4a and 4b are diagrams illustrating a flowchart of an embodiment of a write frequency recording method;

FIG. 5a is a schematic diagram illustrating exemplary recorded data;

FIGS. 5b to 5j are schematic diagrams illustrating exemplary temporary segments in different aspects;

FIG. 6 is a flowchart of an embodiment of a write frequency information duplication method;

FIG. 7 is a diagram of a storage medium for storing a computer program providing an embodiment of a method of write frequency management.

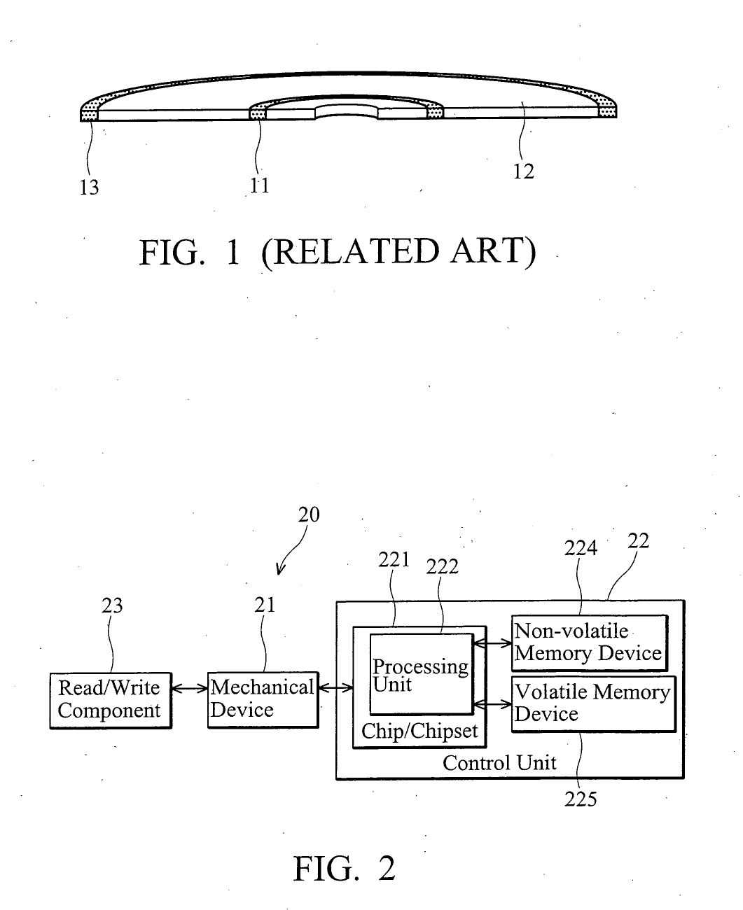

### DETAILED DESCRIPTION

FIG. 2 shows a diagram of an embodiment of an optical read/write apparatus. An embodiment of the optical read/write apparatus 20 comprises a mechanical device 21, a control unit 22 and a read/write component 23. The control unit 22 comprises a chip/chipset 221, a non-volatile memory device 224 and a volatile memory device 225. The non-volatile memory device 224, such as a Read Only Memory (ROM), an Electrically Erasable Programmable Read Only Memory (EEPROM), a flash ROM and the like, retains data after power-down. The volatile memory device 225, such as a Dynamic Random Access Memory (DRAM), a Synchronous DARM (SDRAM) and the like, loses data after power-down. The chip/chipset 221 comprises processing unit 222. Those skilled in the art will recognize that the processing unit 222, non-volatile memory device 224 and/or volatile memory device 225 may be configured in the chip/chipset 221 or outside of the chip/chipset 221. The chip/chipset 221 comprises data reading logic and data writing logic. The data reading logic directs the read/write component 23 to read within a given range of data from an optical storage medium. The data writing logic directs the read/write component 23 to write data in a given range on an optical storage medium. The read/write component 23, mechanical device 21 and the control unit 22 are essential parts of an optical read/write apparatus. Those skilled in the art will recognize that additional or different components may be provided in the optical read/write apparatus. Volatile memory device 225 comprises a buffer.

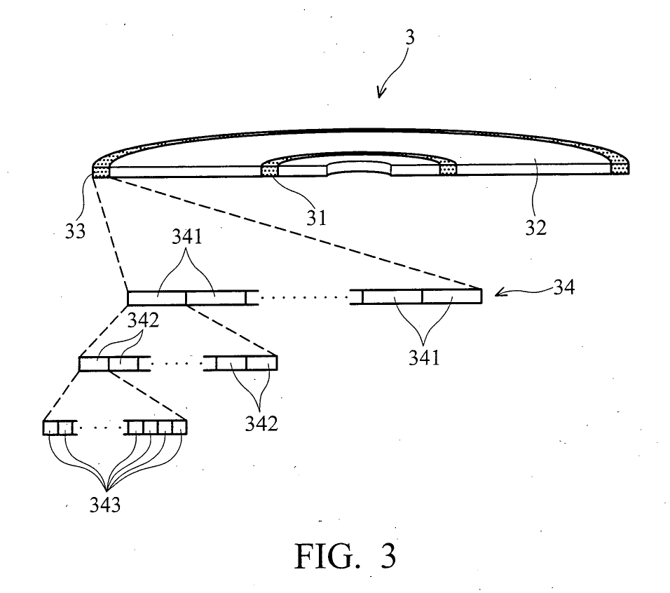

FIG. 3 is a schematic diagram of an embodiment of an optical rewritable storage medium. The optical rewritable storage medium, such as a CD-RW, DVD-RW, DVD+RW and the like, comprises a lead-in area 31, a data/program area 32 and a lead-out area 33. The data/program area 32 stores audio, video or computer data. A data block is a minimum physical unit in the data/program area 32. The optical read/write apparatus 20 employs different writing approaches to write one or more data blocks at one time. For example, when used in a packet writing, thirty-seven data blocks (thirty-two data blocks for data, five data blocks for packet separation or control information) are written as a packet at one time. When used in an error correction code block (ECC block) writing, an ECC block including sixteen data blocks is written at one time. Preferably, the lead-out area comprises a count area 34. It is noted that the count area may be stored in an unoccupied area of a lead-in area or data/program area. In order to prevent excessive updates of the count area 34 from causing failure, the count area 34 is segmented into multiple pages. When a current page 341 is updated a specific number of times, preferably ninety-nine times, write frequency information in a current page is duplicated on the next page. In order to improve efficiency, each page 341 is segmented into multiple segments 342 and each segment 342 stores write frequency information for a portion of data units, such as blocks, packets, ECC blocks or others. As a result, when data is recorded to a portion of the data units, only corresponding segments are updated. Each segment 342 is additionally segmented into multiple count blocks 343, and each count block 343 comprises a field for storing the write frequency for a data unit in the data/program area 32. Note that each count block may store additional information, such as block identity, data unit type, update time or others.

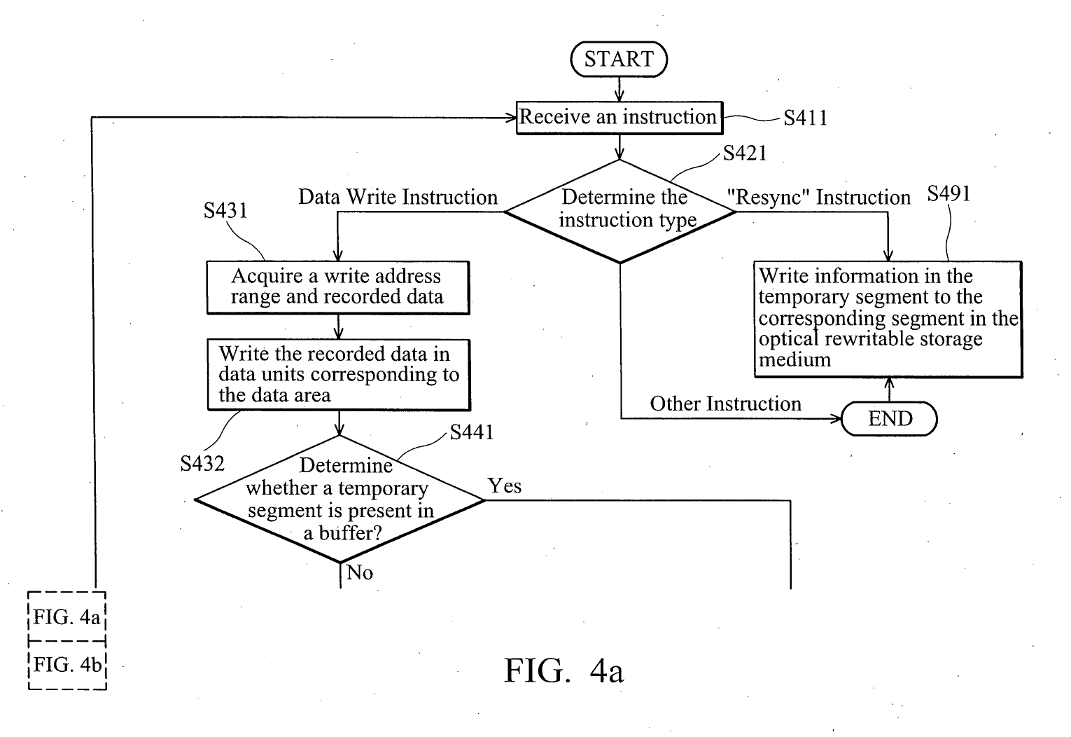

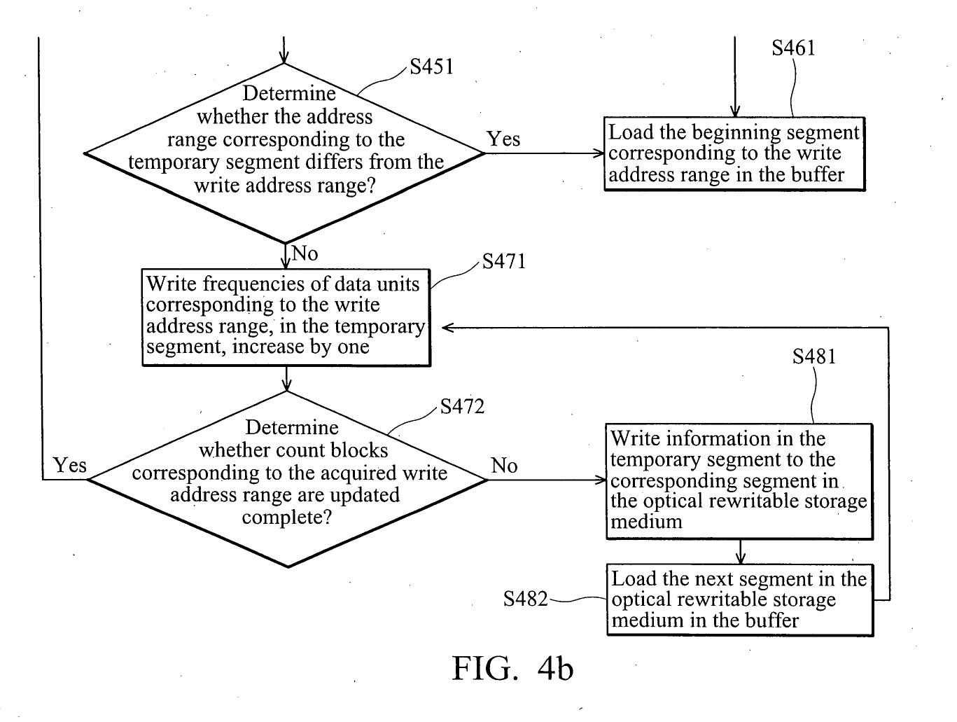

Non-volatile memory device 224 includes a firmware comprising instructions. The firmware is loaded and executed by the processing unit 222 to execute write frequency recording functions when the optical read/write component 20 is directed to write data. FIGS. 4a and 4b are diagrams illustrating a flowchart of an embodiment of a write frequency recording method. It is noted that the method may also be implemented in physical circuits in the optical read/write apparatus 20. The process begins in step S411 to receive an instruction. In step S421, an instruction type is determined, the process proceeds to step S431 when the instruction is a data write instruction, and otherwise, the process proceeds to step S491 when the instruction is a “resync” instruction indicating that the entire writing is complete. Note that the instruction type may further comprise a data read instruction.

In step S431, a write address range and recorded data are acquired. In step S432, the recorded data is written to data units in the data/program area 32. In step S441, it is determined whether a buffer in the volatile memory device 225 comprises a temporary segment storing write frequency information, if so, the process proceeds to step S461, and otherwise, to step S451. In step S451, it is determined whether the acquired write address range differs from an address range of the temporary segment. If so, the process proceeds to step S461, and otherwise, to step S471. In step S461, write frequency information in the beginning segment 342 corresponding to the acquired write address range, is stored in the buffer. In step S471, write frequencies of data units corresponding to the acquired write address range, in the temporary segment, increases by one. In step S472, it is determined whether count blocks in all segments 342 corresponding to the acquired write address range are completely updated, if so, the process proceeds to step S411, and otherwise, to step S481. In step S481, a segment write frequency of the temporary segment increases by one, and writes information in the temporary segment to the corresponding segment 342 in the optical rewritable storage medium. In step S482, write frequency information in the next segment 384 is stored in the buffer. In step S491, a segment write frequency of the temporary segment, increases by one, and writes information in the temporary segment to the corresponding segment 342 in the optical rewritable storage medium.

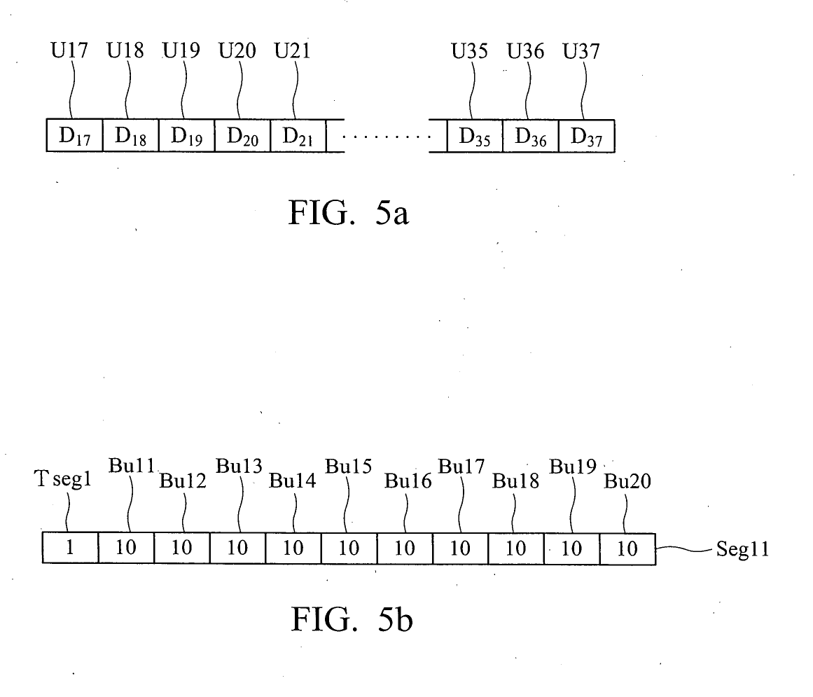

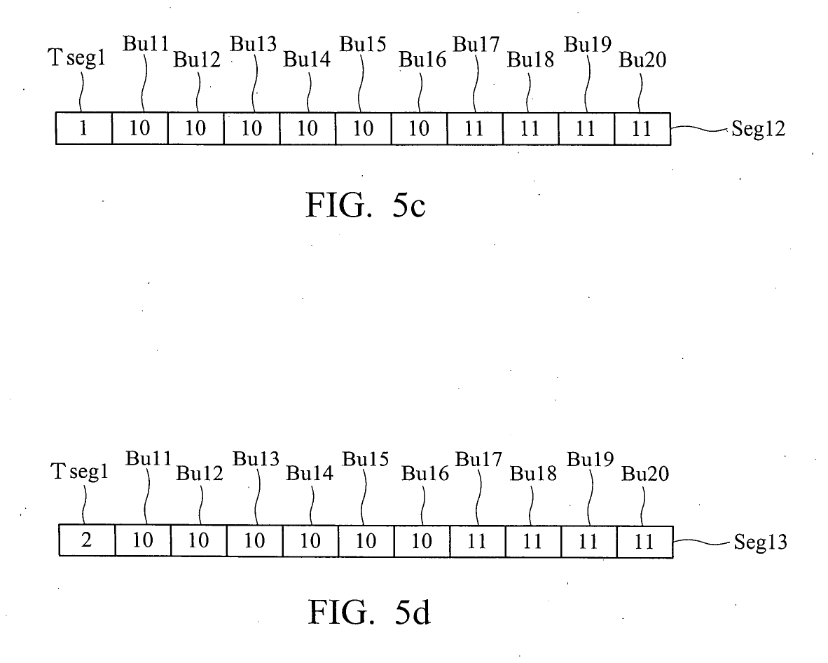

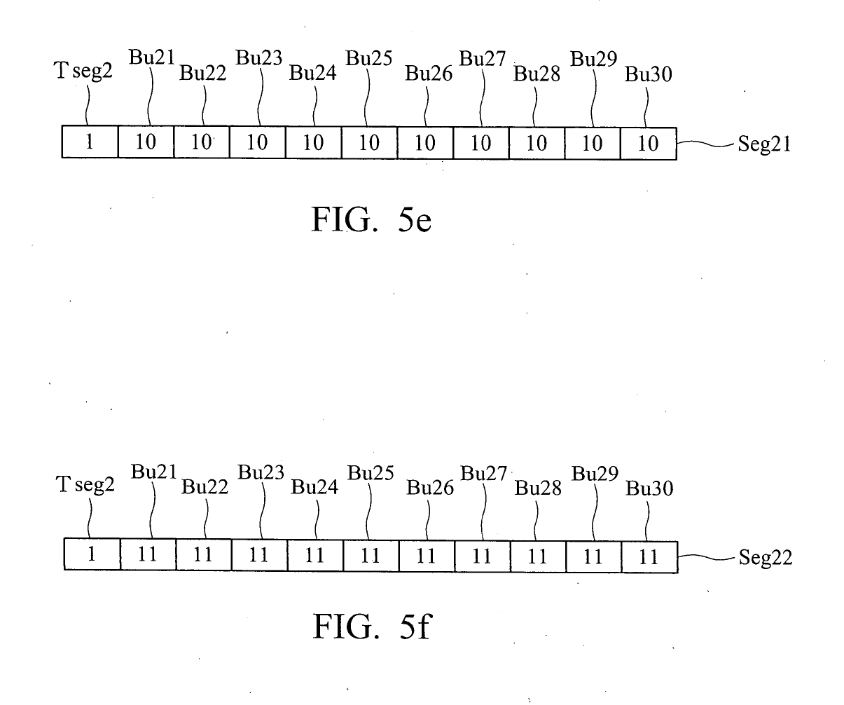

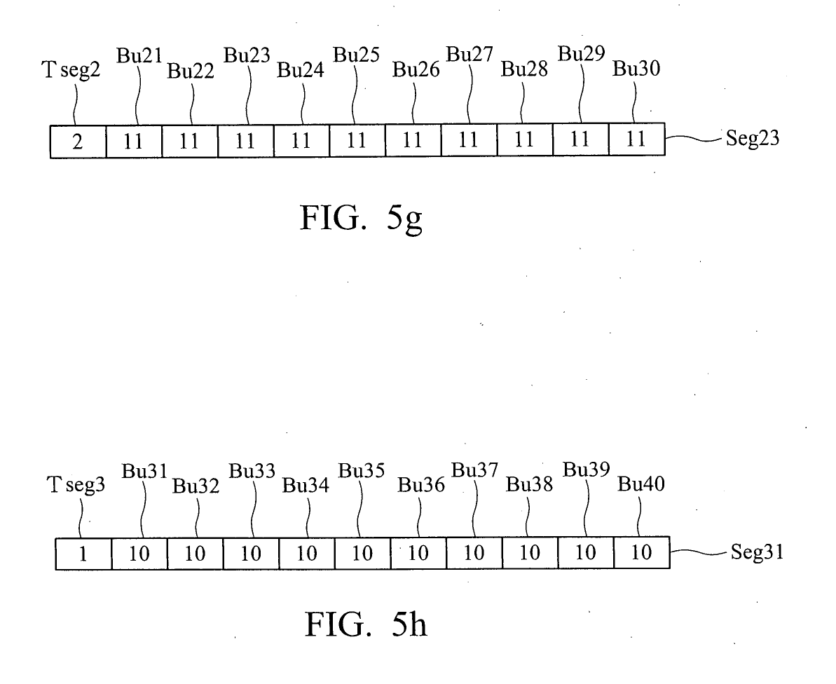

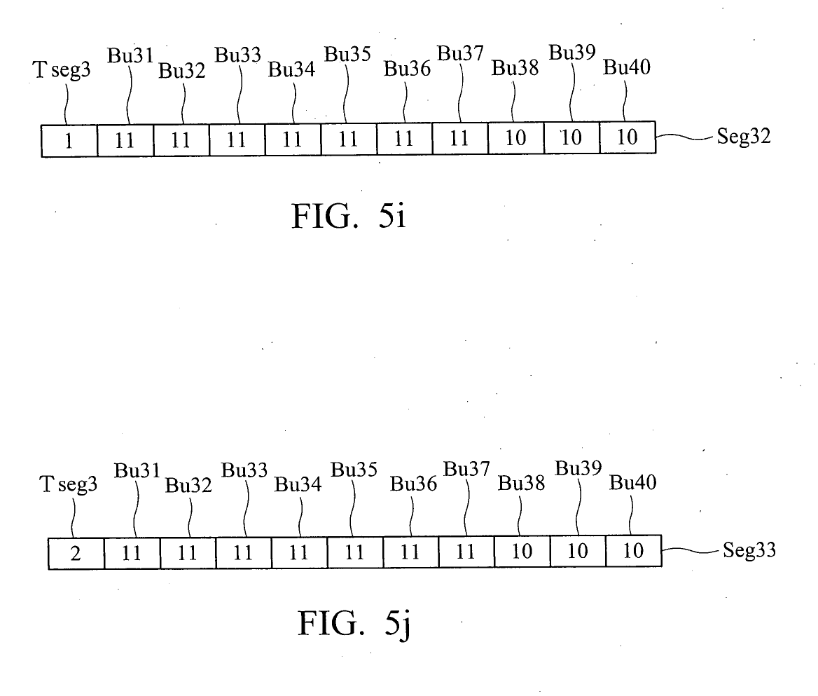

An example of the write frequency recording is further described in the following. FIG. 5a is a schematic diagram illustrating exemplary recorded data. FIGS. 5b to 5j are schematic diagrams illustrating exemplary temporary segments in different aspects. In step S411, a data write instruction is received. In steps S421, S431 and S432, write address range U17 to U37 and recorded data D17 to D37 are acquired, and the recorded data D17 to D37 is sequentially written to write address range U17 to U37 in the data/program area 32. Initially, because there is no temporary segments stored in a buffer, in step S461, write frequencies in a segment (as shown in segment Seg11 of FIG. 5b) are loaded from an optical rewritable storage medium to the buffer. Subsequently, in steps S451 and S471, write frequencies Bu17 to Bu20 corresponding to the write address range U17 to U20, increases by one (the result as shown in Seg12 of FIG. 5c). Because write frequencies corresponding to write address range U21 to U37 are not updated, in steps S472, S481 and S482, a segment write frequency Tseg1 in the temporary segment Seg12 increases by one (the result as shown in Seg13 of FIG. 5d), the write frequency information in the temporary segment Seg13 is written to a corresponding segment in the optical rewritable storage medium, and write frequency information in the next segment (as shown in Seg21 of FIG. 5e) is loaded from the optical rewritable storage medium to the buffer. Subsequently, in steps S451 and S471, write frequencies Bu21 to Bu30 corresponding to the write address range U21 to U30, increases by one (the result as shown in Seg22 of FIG. 5f). Because write frequencies corresponding to write address range U31 to U37 are not updated, in steps S472, S481 and S482, a segment write frequency Tseg2 in the temporary segment Seg22 increases by one (the result as shown in Seg23 of FIG. 5g), the write frequency information in the temporary segment Seg23 is written to a corresponding segment in the optical rewritable storage medium, and write frequency information in the next segment (as shown in Seg31 of FIG. 5h) is loaded from the optical rewritable storage medium to the buffer. Subsequently, in steps S451 and S471, write frequencies Bu31 to Bu37 corresponding to the write address range U31 to U37, increases by one (the result as shown in Seg32 of FIG. 5i). Because write frequencies corresponding to write address range U31 to U37 are completely updated, in step S411, a “resync” instruction is received. In step S491, a segment write frequency Tseg3 in the temporary segment Seg32 increases by one (the result as shown in Seg33 of FIG. 5j), and the write frequency information in the temporary segment Seg33 is written to a corresponding segment in the optical rewritable storage medium.

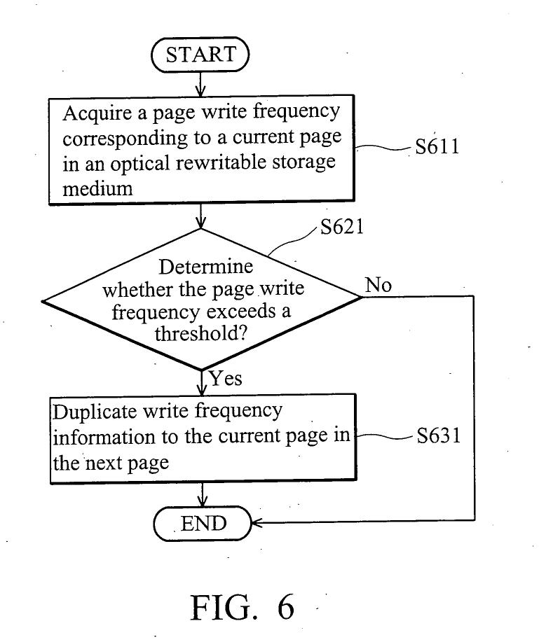

FIG. 6 is a flowchart of an embodiment of a write frequency information duplication method. In step S611, a page write frequency corresponding to a current page 341 is acquired from an optical rewritable storage medium. Preferably, the page write frequency is equal to a maximum value in all segment write frequencies. In step S621, it is determined whether the page write frequency exceeds a threshold, if so, the process proceeds to step S631, and otherwise, the process ends. In step S631, write frequency information in the current page is duplicated on the next new page.

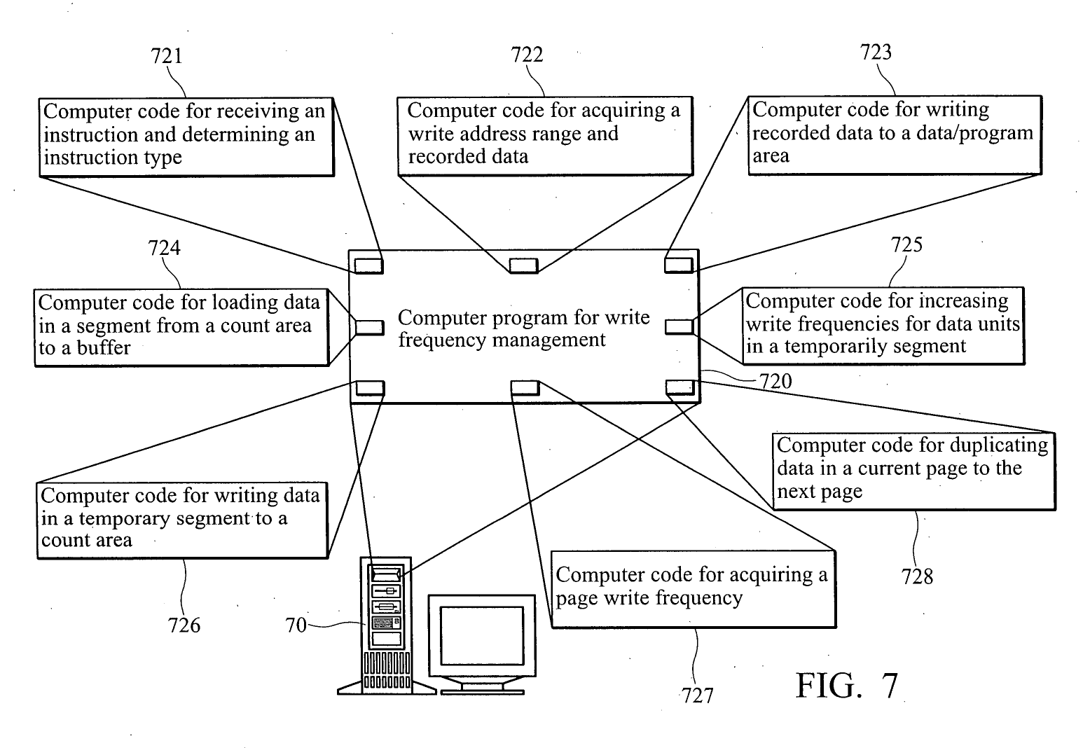

Also disclosed is a storage medium as shown in FIG. 7 storing a computer program 720 providing the disclosed methods of write frequency recording and duplication. The computer program product includes a storage medium 70 having computer readable program code embodied in the medium for use in a computer system. The computer readable program code comprises at least computer readable program code 721 receiving an instruction and determining an instruction type, computer readable program code 722 acquiring a write address range and recorded data, computer readable program code 723 writing data to a data/program area, computer readable program code 724 loading data in a segment from a count area to a buffer, computer readable program code 725 increasing write frequencies for data units in a temporary segment, computer readable program code 726 writing data in a temporary segment to a count area, computer readable program code 727 acquiring a page write frequency, and computer readable program code 728 duplicating data in a current page to the next page.

Optical read/write apparatuses and write frequency management methods, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by a machine, such as a computer or an optical storage device, the machine becomes an apparatus for practicing the invention. When implemented on a general-purpose processor, the program code combines with the processor to provide a unique apparatus that operates analogously to specific logic circuits.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. A method of write frequency management loaded and executed by a processing unit in an optical read/write apparatus, writing recorded data to an optical rewritable storage medium comprising a data area and a count area, the data area comprising a plurality of data units, the count area comprising a plurality of values, each value representing a write frequency corresponding to one of the data units, the method comprising the steps of:
receiving a data write instruction comprising a write address range and the recorded data;
writing the recorded data to the data units corresponding to the write address range; and
updating the values corresponding to the write address range.

2. The method as claimed in claim 1 wherein the count area comprises at least one segment, each segment comprises at least one block, and each block comprises a portion of the values.

3. The method as claimed in claim 2 wherein the step of updating further comprises the steps of:
loading the values in the segment corresponding to the write address range from the count area to a buffer;
updating each value corresponding to the write address range in the buffer; and
writing the values in the buffer to the corresponding segment.

4. The method as claimed in claim 2 wherein the count area comprises a plurality of pages, the page comprises all segments, and each segment comprises a segment write frequency.

5. The method as claimed in claim 4 further comprising the steps of:
acquiring the segment write frequency in the segment in the buffer,
updating the acquired segment write frequency; and
writing the updated segment write frequency to the corresponding segment in the count area.

6. The method as claimed in claim 5 further comprising:
acquiring all segment write frequencies in the page;
acquiring a maximum segment write frequency among the acquired segment write frequencies;
determining whether the maximum segment write frequency exceeds a threshold; and
duplicating data in the page to the next page if the maximum segment write frequency exceeds the threshold.

7. The method as claimed in claim 6 wherein the threshold is between 90 and 110.

8. A machine-readable storage medium for storing a computer program which, when executed, performs a method of write frequency management, writing recorded data to an optical rewritable storage medium comprising a data area and a count area, the data area comprising a plurality of data units, the count area comprising a plurality of values, each value representing a write frequency corresponding to one of the data units, the method comprising the steps of:
receiving a data write instruction comprising a write address range and the recorded data;
writing the recorded data to the data units corresponding to the write address range; and
updating the values corresponding to the write address range.

9. An apparatus for writing recorded data to an optical rewritable storage medium comprising a data area and a count area, the data area comprising a plurality of data units, the count area comprising a plurality of values, each value representing a write frequency corresponding to one of the data units, the apparatus comprising:
a read/write component; and
a processing unit,
wherein the processing unit receives a data write instruction comprising a write address range and the recorded data, directs the read/write component to write the recorded data to the data units corresponding to the write address range, and directs the read/write component to update the values corresponding to the write address range.

10. The apparatus as claimed in claim 9 wherein the count area comprises at least one segment, each segment comprises at least one block, and each block comprises a portion of the values.

11. The apparatus as claimed in claim 10 wherein the processing unit directs the read/write component to load the values in the segment corresponding to the write address range from the count area to a buffer, update each value corresponding to the write address range in the buffer, and write the values in the buffer to the corresponding segment.

12. The apparatus as claimed in claim 10 wherein the count area comprises a plurality of pages, the page comprises all segments, and each segment comprises a segment write frequency.

13. The apparatus as claimed in claim 12 wherein the processing unit directs the read/write component to acquire the segment write frequency in the segment in the buffer, update the acquired segment write frequency, and write the updated segment write frequency to the corresponding segment in the count area.

14. The apparatus as claimed in claim 13 wherein the processing unit directs the read/write component to acquire all segment write frequencies in the page, acquires a maximum segment write frequency among the acquired segment write frequencies, determines whether the maximum segment write frequency exceeds a threshold, and duplicates data in the page to the next page if the maximum segment write frequency exceeds the threshold.

15. The apparatus as claimed in claim 14 wherein the threshold is between 90 and 110.

16. An optical rewritable storage medium comprising:
a data area comprising a plurality of data units; and
a lead-out area comprising a count area, the count area comprising a plurality of values, each value representing a write frequency corresponding to one of the data units.

17. The optical rewritable storage medium as claimed in claim 16 is a CD-RW, DVD-RW or DVD+RW.

18. The optical rewritable storage medium as claimed in claim 16 wherein the count area comprises at least one segment, each segment comprises at least one block, and each block comprises a portion of the values.

19. The optical rewritable storage medium as claimed in claim 18 wherein the count area comprises a plurality of pages, the page comprises all segments, and each segment comprises a segment write frequency.

20. The optical rewritable storage medium as claimed in claim 18 wherein the data unit is a data block, a packet or an error correction code (ECC) block.
